(19) United States
(12) Patent Application Publication
(10) Pub. No.: US 2024/0246579 A1
(43) Pub. Date: Jul. 25, 2024

(54) ALUMINUM ALLOY METRO VEHICLE BODY SECTION BAR CAPABLE OF MATCHING AND COMBINING

(71) Applicant: CRRC Nanjing Puzhen Co., Ltd., Nanjing (CN)

(72) Inventors: Xiaowei CHEN, Nanjing (CN); Ming LI, Nanjing (CN); Shixi OU, Nanjing (CN); Lin ZHANG, Nanjing (CN)

(73) Assignee: CRRC Nanjing Puzhen Co., Ltd., Nanjing (CN)

(21) Appl. No.: 18/559,822

(22) PCT Filed: Oct. 14, 2021
(86) PCT No.: PCT/CN2021/123697

§ 371 Date: Nov. 9, 2023

(30) Foreign Application Priority Data
Jul. 23, 2021 (CN) 202110838117.7

(51) Int. Cl. B61D 17/04; B61D 17/08; B61D 17/10; B61D 17/12

(52) U.S. Cl. CPC B61D 17/041; B61D 17/045; B61D 17/08; B61D 17/10; B61D 17/12

(57) ABSTRACT

An aluminum alloy metro vehicle body section bar capable of matching and combining includes a roof section bar, an upper edge beam section bar, a side wall section bar, a lower edge beam section bar and a floor section bar, wherein the roof section bar comprises roof edge section bars of two widths; the upper edge beam section bar comprises an upper edge beam of a drum-shaped vehicle and an upper edge beam 4b of the trapezoidal vehicle; the side wall section bar comprises a side wall middle section bar of the drum-shaped vehicle and a side wall middle section bar of the trapezoidal vehicle; the lower edge beam section bar comprises a lower edge beam of the drum-shaped vehicle and a lower edge beam of the trapezoidal vehicle; and the floor section bar comprises underframe edge section bars of two widths.

### CROSS REFERENCE TO THE RELATED APPLICATIONS

This application is the national phase entry of International Application No. PCT/CN2021/123697, filed on Oct. 14, 2021, which is based upon and claims priority to Chinese Patent Application No. 202110838117.7, filed on Jul. 23, 2021, the entire contents of which are incorporated herein by reference.

### TECHNICAL FIELD

The present invention relates to rail vehicle body structures, and in particular to an aluminum alloy metro vehicle body section bar capable of matching and combining, primarily for the production of types A/B and drum/trapezoid vehicle bodies.

### BACKGROUND

At present, there are two kinds of aluminum alloy metro vehicle bodies widely used in China, which are A-type and type B. The two types of vehicle bodies have two sections of drum and trapezoid respectively. Welding is the main method for the connection and assembly of each part of the vehicle body. A wide variety of vehicle body section bars not only cost a lot of design costs and mold opening costs, but also is not conducive to improve the product process stability and quality.

Without considering the interface with the vehicle body and other systems, there are four types of vehicle bodies when only the combination of vehicle type and cross section is considered. A welded aluminum alloy vehicle body section usually consists of 12 kinds, 22 section bars. If four vehicle body sections are designed separately, 48 kinds of section bars are needed. At present, the section bars of various vehicle bodies are mostly designed separately. They are not in common use for the A-type vehicle and the B-type vehicle, and not in common use for the drum-shaped vehicle and the trapezoidal vehicle. Due to the lack of compatibility and interchangeability among the four vehicle bodies, development and production costs are increased.

### SUMMARY

The object of the present invention is mainly directed to solve the above-mentioned problem of four types of vehicle bodies not in common use in the prior art, and to provide an aluminum alloy metro vehicle body section bar capable of matching and combining. Different vehicle models and different sections of vehicle bodies may be produced by replacing a small number of section bars.

In order to solve the above technical problem, the present invention provides an aluminum alloy metro vehicle body section bar capable of matching and combining, comprising a roof section bar, an upper edge beam section bar, a side wall section bar, a lower edge beam section bar and a floor section bar, the adjacent section bars being fixedly connected to form a vehicle body, wherein the roof section bar comprises roof edge section bars of two widths to respectively adapt to an A-type vehicle and a B-type vehicle; the upper edge beam section bar comprises an upper edge beam of a drum-shaped vehicle and an upper edge beam 4b of an trapezoidal vehicle to respectively adapt to the drum-shaped vehicle and the trapezoidal vehicle; the side wall section bar comprises a side wall middle section bar of the drum-shaped vehicle and a side wall middle section bar of the trapezoidal vehicle to respectively adapt to the drum-shaped vehicle and the trapezoidal vehicle; the lower edge beam section bar comprises a lower edge beam of the drum-shaped vehicle and a lower edge beam of the trapezoidal vehicle to respectively adapt to the drum-shaped vehicle and the trapezoidal vehicle; and the floor section bar comprises underframe edge section bars of two widths to respectively adapt to the A-type vehicle and the B-type vehicle.

Further, the roof section bar comprises a first roof section bar located in the middle of the roof and a second roof section bar located between the first roof section bar and the roof edge section bar; and the first roof section bar, the second roof section bar and the roof edge section bar are fixed in sequence by plug-in connection and welding.

Further, the floor section bar comprises a first floor section bar located in the middle of the floor and a second floor section bar located between the first floor section bar and the underframe edge section bar; and the first floor section bar, the second floor section bar and the underframe edge section bar are fixed in sequence by plug-in connection and welding.

Furthermore, the side wall section bar comprises a first side wall section bar, a second side wall section bar, a side wall middle section bar and a third side wall section bar which are successively connected from top to bottom; the first side wall section bar, the second side wall section bar, the side wall middle section bar and the third side wall section bar are fixed in sequence by plug-in connection and welding; an upper end of the first side wall section bar is fixed to the upper edge beam by plug-in connection and welding; and the third side wall section bar is fixed to the lower edge beam by plug-in connection and welding.

In addition, the present invention provides a method for designing an aluminum alloy metro vehicle body, wherein based on the aluminum alloy metro vehicle body section bar of claim 1, it adapts to different cross-section vehicle bodies by replacing the roof edge section bar, an upper edge beam of a drum-shaped vehicle and an upper edge beam 4b of an trapezoidal vehicle, a side wall middle section bar of the drum-shaped vehicle and a side wall middle section bar of the trapezoidal vehicle, a lower edge beam of the drum-shaped vehicle, a lower edge beam of the trapezoidal vehicle, and an underframe edge section bar.

In the present invention, by optimizing the section bar design and increasing the sharing ratio of section bars, the section bars can be maximally compatible with various vehicle types. The cross-section construction of vehicle bodies of A-type trapezoidal vehicle, A-type drum-shaped vehicle, B-type trapezoidal vehicle and B-type drum-shaped vehicle are implemented by only 17 types of section bars. The vehicle body section bar of the present invention is compatible to the two types of vehicle types of A and B and the two types of sections of trapezoidal and drum shape, so that the vehicle body section bar may achieve the maximum universalization among the vehicle types. By means of the present invention, it is possible to save design costs and mold opening costs of the section bar, solidify the vehicle body welding process and stabilize the product quality.

### BRIEF DESCRIPTION OF THE DRAWINGS

FIG. 1 is an alternative schematic view of an A-type drum-shaped vehicle body and an A-type trapezoidal vehicle body.

FIG. 2 is an alternative schematic view of a B-type drum-shaped vehicle body and a B-type trapezoidal vehicle body.

FIG. 3 is an alternative schematic view of an A-type drum-shaped vehicle body and a B-type trapezoidal vehicle body.

FIG. 4 is an alternative schematic view of a B-type drum-shaped vehicle body and an A-type trapezoidal vehicle body.

The reference numbers in the drawings are as follows.

1—first roof section bar, 2—second roof section bar, 3a—A-type roof edge section bar, 3b—B-type roof edge section bar, 4a—upper edge beam of the drum-shaped vehicle, 4b—upper edge beam 4b of the trapezoidal vehicle, 5—first side wall section bar, 6—second side wall section bar, 7a—side wall middle section bar of the drum-shaped vehicle, 7b—side wall middle section bar of the trapezoidal vehicle, 8—third side wall section bar, 9a—lower edge beam of the drum-shaped vehicle, 9b—lower edge beam of the trapezoidal vehicle, 10a—underframe edge section bar of the A-type vehicle, 10b—underframe edge section bar of the B-type vehicle, 11—second floor section bar, 12—first floor section bar.

### DETAILED DESCRIPTION OF THE EMBODIMENTS

Hereinafter, embodiments of the present invention will be explained with reference to the accompanying drawings.

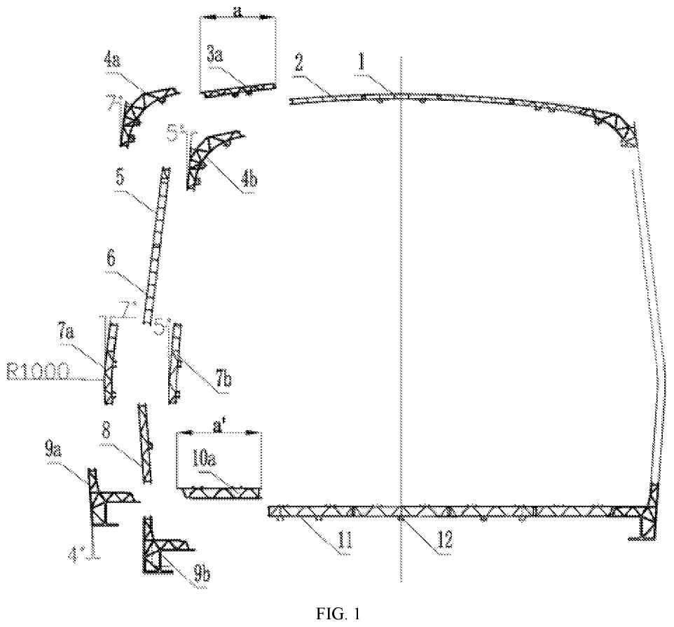

As shown in FIGS. 1-4, the present embodiment may be combined with an aluminum alloy metro vehicle body section bar, including a roof section bar, an upper edge beam section bar, a side wall section bar, a lower edge beam section bar and a floor section bar, the adjacent section bars being fixed by plug welding to form a vehicle body.

The roof section bar includes a first roof section bar 1 located in the middle of the roof, a second roof section bar 2 located on both sides of the first roof section bar 1 and a roof edge section bar located on the outside of the second roof section bar 2. The roof edge section bar has two sizes, namely an A-type roof edge section bar 3a and a B-type roof edge section bar 3b, to adapt to an A-type vehicle and a B-type vehicle, respectively. The first roof section bar 1, the second roof section bar 2 and the roof edge section bar (3a, 3b) are fixed in sequence by plug-in connection and welding.

The upper edge beam section bar has two specifications, an upper edge beam of a drum-shaped vehicle 4a and an upper edge beam 4b of a trapezoidal vehicle to adapt to the drum-shaped vehicle and the trapezoidal vehicle, respectively. The upper edge beam 4a of the drum-shaped vehicle has a greater leaning angle, preferably in degrees of 7 (a solution in FIG. 1). The upper edge beam 4b of the trapezoidal vehicle has a smaller leaning angle, preferably in degrees of 5 (a solution in FIG. 1). An upper end of the upper edge beam section bar is fixed to the roof edge section bar (3a, 3b) by plug-in connection and welding.

The side wall section bar includes, from top to bottom, a first side wall section bar 5, a second side wall section bar 6, a side wall middle section bar and a third side wall section bar 8 which are fixed in sequence by plug-in connection and welding. The side wall middle section bar has two sizes, a side wall middle section bar 7a of the drum-shaped vehicle and a side wall middle section bar 7b of the trapezoidal vehicle, to respectively adapt to the drum-shaped vehicle and the trapezoidal vehicle. The drum-shaped vehicle has an outward protrusion in the middle of the sidewall. A width of the drum-shaped vehicle in the middle of the sidewall is greater than that of the trapezoidal vehicle, and a leaning angle in the middle of the sidewall is greater, preferably 7 degrees (the solution of the present embodiment). The leaning angle of the trapezoidal vehicle in the middle of the sidewall is small, preferably, 5 degrees (the solution of the present embodiment). An upper end of the first side wall section bar 5 is fixed to the upper edge beams (4a, 4b) by plug-in connection and welding, and the third side wall section bar 8 is fixed to the lower edge beam section bars (9a, 9b) by plug-in connection and welding.

The lower edge beam section bar also has two specifications, a drum-shaped vehicle lower edge beam 9a and a trapezoid vehicle lower edge beam 9b, to respectively adapt to a drum-shaped vehicle and a trapezoid vehicle. The lower edge beam of the drum-shaped vehicle has a greater camber angle. Preferably, the degree of camber angle is 4 degrees. The lower edge beam of the trapezoid vehicle is then almost perpendicular to the underframe floor.

The floor section bar includes a first floor section bar 12 in the middle of the floor and a second floor section bar 11 on both sides of the first floor section bar 12, and an underframe edge section bar on the outside of the second floor section bar 11. The first floor section bar 12, the second floor section bar 11 and the underframe edge section bar are fixed in sequence by plug-in connection and welding. The underframe edge section bar has two widths, an A-type underframe edge section bar 10a and a B-type underframe edge section bar 10b, to respectively adapt to an A-type underframe and a B-type underframe. The outer ends of the underframe edge section bars are fixed to the lower edge beam section bars (9a, 9b) by plug-in connection and welding.

The present invention achieves material selection and assembly of trapezoidal and drum-shaped sections of the same vehicle type and material selection and assembly of trapezoidal and drum-shaped sections of different vehicle types with fewer section bars. The structural transformation of the vehicle body may be realized by replacing three kinds of (6 pieces) sections between the trapezoidal section and the drum-shaped section of the same vehicle. The transformation of body structure may be realized by replacing five kinds (10 pieces) between trapezoidal and drum-shaped body sections of different vehicle types (A-type trapezoidal and B-type drum-shaped, A-type drum-shaped and B-type trapezoidal).

With regard to the body of the drum-shaped vehicle, it includes an upper edge beam 4a of the drum-shaped vehicle, a drum-shaped side wall middle section bar 7a and a drum-shaped lower edge beam 9a. The trapezoidal vehicle body includes an upper edge beam 4b of the trapezoidal vehicle, a side wall middle section bar 7b of the trapezoidal vehicle and a lower edge beam 9a of the drum-shaped vehicle. An A-type vehicle body includes a roof edge section bar 3a of the A-type vehicle and an underframe edge section bar 10a of the A-type vehicle. The B-type vehicle body includes a roof edge section bar 3b of the B-type vehicle and an underframe edge section bar 10b of the B-type vehicle. The rest are common components.

Specifically, the A-type drum-shaped vehicle and the A-type trapezoidal vehicle body share the first roof section bar 1, the second roof section bar 2, the A-type roof edge section bar 3a, the first side wall section bar 5, the second side wall section bar 6, the third side wall section bar 8, the first floor section bar 12, the second floor section bar 11, and the A-type underframe edge section bar 10a. A B-type drum-shaped vehicle and a B-type trapezoidal vehicle body share a first roof section bar 1, a second roof section bar 2, a roof edge section bar 3b of the B-type vehicle, a first side wall section bar 5, a second side wall section bar 6, a third side wall section bar 8, a first floor section bar 12, a second floor section bar 11 and an underframe edge section bar 10b of the B-type vehicle.

The present invention also provides a method for designing an aluminum alloy metro vehicle body. Based on the aluminum alloy metro vehicle body section bar described above, it adapts to different cross-section vehicle bodies by replacing the roof edge section bars (3a, 3b), an upper edge beam 4a of the drum-shaped vehicle and an upper edge beam 4b of the trapezoidal vehicle, a side wall middle section bar 7a of the drum-shaped vehicle and a side wall middle section bar 7b of the trapezoidal vehicle, a lower edge beam 9a of the drum-shaped vehicle, a lower edge beam 9b of the trapezoidal vehicle, and underframe edge section bar (10a, 10b).

converting an A-type vehicle body to a B-type vehicle body comprises replacing the roof edge section bar 3a of the A-type vehicle with the roof edge section bar 3b of the B-type vehicle, and replacing the underframe edge section bar 10a of the A-type vehicle with the underframe edge section bar 10b of the B-type vehicle; wherein the reverse operation is performed when the B-type vehicle body is converted to the A-type vehicle body.

Converting the same type of drum-shaped vehicle body into a trapezoidal vehicle body requires the following operations including: replacing the upper edge beam 4a of the drum-shaped vehicle with the upper edge beam 4b of the trapezoidal vehicle, replacing the side wall middle section bar 7a of the drum-shaped vehicle with the side wall middle section bar 7b of the trapezoidal vehicle, and replacing the lower edge beam 9a of the drum-shaped vehicle with the lower edge beam 9b of the trapezoidal vehicle; wherein the reverse operation is performed when the same type of trapezoidal vehicle body is converted into the drum-shaped vehicle body.

Four variations of the aluminum alloy metro body are provided below with reference to the drawings.

As shown in FIG. 1, it is an alternative schematic view of an A-type drum-shaped vehicle body and an A-type trapezoidal vehicle body.

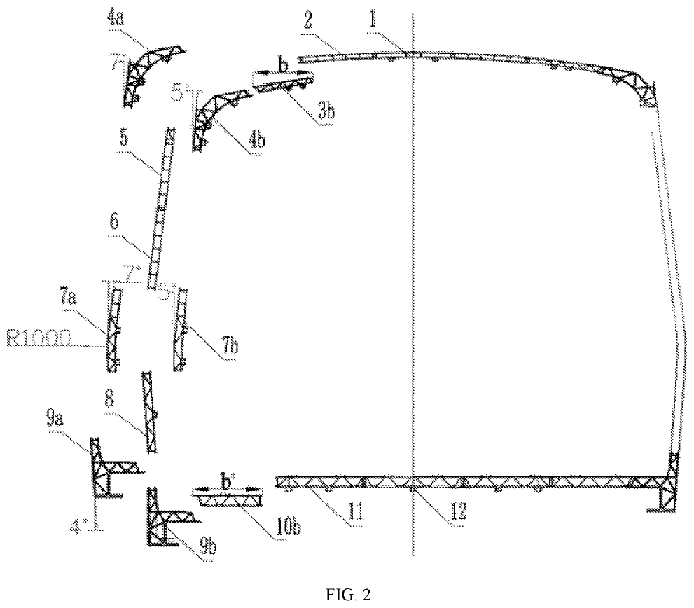

The upper edge beams (4a, 4b), the adjacent roof section bar 3a and the first side wall section bar 5 are all plug-in connection structures, and are connected by welding. Arc welding and friction stir welding (FSW) are considered at the same time to maximize the sharing rate of vehicle body platform section bars. Specifically, the upper edge beam 4a of the A-type drum-shaped vehicle, the roof section bar 3a and the first side wall section bar 5 are plug-in connection structures. The Upper edge beam 4b of the A-type trapezoidal vehicle, the roof section bar 3a and the first side wall section bar 5 are plug-in connection structures. The side wall section bars (7a, 7b) and the adjacent side wall section bars 6 and 8 are all plug-in connection structures and are connected by welding. Specifically, the side wall middle section bar 7a of the A-type drum-shaped vehicle, the side wall section bar 6 and the side wall section bar 8 are all plug-in connection structures. The A-type trapezoidal vehicle side wall section bar 7b, the side wall section bar 6 and the side wall section bar 8 are all plug-in connection structures. The lower edge beams (9a, 9b), the adjacent floor section bar 10a and the adjacent side wall section bar 8 are plug-in connection structures and are connected by welding. Specifically, the lower edge beam 9a of the A-type drum-shaped vehicle, the floor section bar 10a and the side wall section bar 8 are all plug-in connection structures. The lower edge beam 9b of the A-type trapezoidal vehicle, the floor section bar 10a and the side wall section bar 8 are all plug-in connection structures. When the sections of the A-type drum-shaped vehicle and the A-type trapezoidal vehicle body are replaced, the upper edge beam 4a of the drum-shaped vehicle is replaced with the upper edge beam 4b of the trapezoidal vehicle; the side wall middle section bar 7a of the drum-shaped vehicle is replaced with a side wall middle section bar 7b of the trapezoidal vehicle; and the lower edge beam 9a of the drum-shaped vehicle may be replaced with a lower edge beam 9b of the trapezoidal vehicle. Vice versa. As shown in FIG. 2, it is an alternative schematic view of a B-type drum-shaped vehicle body and a B-type trapezoidal vehicle body.

The upper edge beams (4a, 4b), the adjacent roof section bar 3b and side wall section bar 5 are all plug-in connection structures and are connected by welding. Specifically, the upper edge beam 4a of the B-type drum-shaped vehicle, the roof section bar 3b and the first side wall section bar 5 are all plug-in connection structures. The upper edge beam 4b of the B-type trapezoidal vehicle, the roof section bar 3b and the first side wall section bar 5 are plug-in connection structures. The side wall section bars (7a, 7b), the adjacent second side wall section bars 6 and third side wall section bars 8 are all plug-in connection structures and are connected by welding. Specifically, the B-type drum-shaped vehicle side wall section bar 7a, the second side wall section bar 6 and the third side wall section bar 8 are all plug-in connection structures. The B-type trapezoidal vehicle side wall section bar 7b, the second side wall section bar 6 and the third side wall section bar 8 are all plug-in connection structures. The lower edge beams (9a, 9b), the adjacent underframe edge section bar 10b and the adjacent third side wall section bar 8 are all plug-in connection structures and are connected by welding. Specifically, the lower edge beam 9a of the B-type drum-shaped vehicle, the floor section bar 10b and the side wall section bar 8 are all plug-in connection structures. The lower edge beam 9b of the B-type trapezoidal vehicle, the floor section bar 10b and the side wall section bar 8 are all plug-in connection structures. When the sections of the B-type drum-shaped vehicle and the trapezoidal vehicle body are replaced, the upper edge beam 4a of the drum-shaped vehicle is replaced with the upper edge beam 4b of the trapezoidal vehicle; the side wall middle section bar 7a of the drum-shaped vehicle is replaced with a side wall middle section bar 7b of the trapezoidal vehicle; and the lower edge beam 9a of the drum-shaped vehicle may be replaced with a lower edge beam 9b of the trapezoidal vehicle. Vice versa.

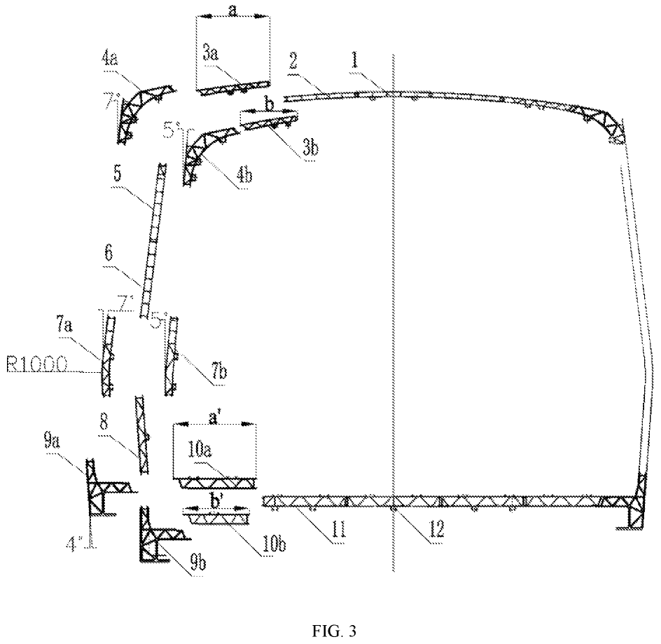

As shown in FIG. 3, it is an alternative schematic view of an A-type drum-shaped vehicle body and a B-type trapezoidal vehicle body.

The upper edge beam (4a, 4b), the adjacent roof edge section bar (3a, 3b) and the first side wall section bar 5 are all plug-in connection structures and are connected by welding. Specifically, the upper edge beam 4a of the A-type drum-shaped vehicle, the roof edge section bar 3a and the first side wall section bar 5 are plug-in connection structures. The upper edge beam 4b of the B-type trapezoidal vehicle, the roof edge section bar 3b and the first side wall section bar 5 are all plug-in connection structures. The side wall middle section bars (7a, 7b), the adjacent second side wall section bar 6 and third side wall section bar 8 are all plug-in connection structures and are connected by welding. Specifically, the side wall middle section bar 7a of the A-type drum-shaped vehicle, the second side wall section bar 6 and the third side wall section bar 8 are all plug-in connection structures. The Side wall middle section bar 7b of the B-type trapezoidal vehicle, the second side wall section bar 6 and the third side wall section bar 8 are all plug-in connection structures. The lower edge beams (9a, 9b), the adjacent underframe edge section bars (10a, 10b) and the adjacent third side wall section bars 8 are all plug-in connection structures and are connected by welding. Specifically, the lower edge beam 9a of the A-type drum-shaped vehicle, the underframe edge section bar 10a and the third side wall section bar 8 are all plug-in connection structures. The lower edge beam 9b of the B-type trapezoidal vehicle, the underframe edge section bar 10b and the third side wall section bar 8 are all plug-in connection structures. When the sections of the A-type drum-shaped vehicle and the B-type trapezoidal vehicle body are replaced, the roof edge section bar 3a of the A-type drum-shaped vehicle is replaced with the roof edge section bar 3b of the B-type trapezoidal vehicle; the upper edge beam 4a of the A-type drum-shaped vehicle is replaced with an upper edge beam 4b of the B-type trapezoidal vehicle; the side wall middle section bar 7a of the A-type drum-shaped vehicle is replaced with a side wall middle section bar 7b of the B-type trapezoidal vehicle; the lower edge beam 9a of the A-type drum-shaped vehicle is replaced with a lower edge beam 9b of the B-type trapezoidal vehicle; and the A-type drum-shaped vehicle underframe side section 10a may be replaced with a B-type trapezoidal vehicle underframe side section 10b. Vice versa.

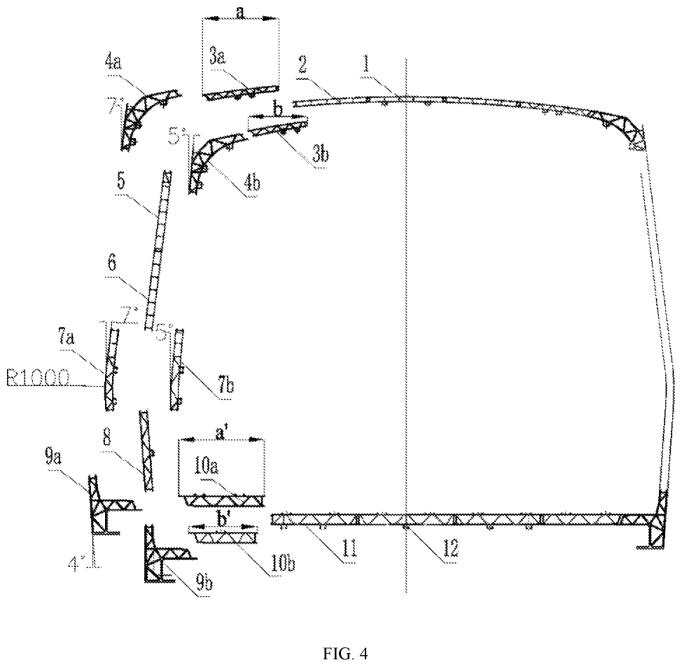

As shown in FIG. 4, it is an alternative schematic view of a B-type drum-shaped vehicle body and an A-type trapezoidal vehicle body.

The upper edge beam (4a, 4b), the adjacent roof edge section bar (3a, 3b) and the first side wall section bar 5 are all plug-in connection structures and are connected by welding. Specifically, the upper edge beam 4a of the B-type drum-shaped vehicle, the roof edge section bar 3b and the first side wall section bar 5 are plug-in connection structures. The upper edge beam 4b of the A-type trapezoidal vehicle, the roof edge section bar 3a and the first side wall section bar 5 are plug-in connection structures. The vehicle side wall middle section bars (7a, 7b) and the adjacent second side wall section bars 6 and third side wall section bars 8 are all plug-in connection structures and are connected by welding. Specifically, the side wall middle section bar 7a of the B-type drum-shaped vehicle, the second side wall section bar 6 and the third side wall section bar 8 are all plug-in connection structures. The Side wall middle section bar 7b of the A-type trapezoidal vehicle, the second side wall section bar 6 and the third side wall section bar 8 are all plug-in connection structures. The lower edge beams (9a, 9b), the adjacent underframe edge section bars (10, 10b) and the adjacent third side wall section bar 8 are all plug-in connection structures and are connected by welding. Specifically, the lower edge beam 9a of the B-type drum-shaped vehicle, the underframe edge section bar 10b and the third side wall section bar 8 are all plug-in connection structures. The lower edge beam 9b of the A-type trapezoidal vehicle, the underframe edge section bar 10a and the third side wall section bar 8 are all plug-in connection structures. When the sections of the B-type drum-shaped vehicle and the A-type trapezoidal vehicle body are replaced, the roof edge section bar 3b of the B-type drum-shaped vehicle is replaced with the roof edge section bar 3a of the A-type trapezoidal vehicle; the upper edge beam 4a of the B-type drum-shaped vehicle is replaced with an upper edge beam 4b of the A-type trapezoidal vehicle; the side wall middle section bar 7a of the B-type drum-shaped vehicle is replaced with a side wall middle section bar 7b of the A-type trapezoidal vehicle; the lower edge beam 9a of the B-type drum-shaped vehicle is replaced with a lower edge beam 9b of the A-type trapezoidal vehicle; and the underframe edge section bar 10b of the B-type drum-shaped vehicle may be replaced with an underframe edge section bar 10a of the A-type trapezoidal vehicle. Vice versa. It can be seen that the present invention achieves material selection and assembly of trapezoidal and drum-shaped sections of the same vehicle type and material selection and assembly of trapezoidal and drum-shaped sections of different vehicle types with fewer section bars. The structural transformation of the vehicle body may be realized by replacing three kinds of (6 pieces) sections between the trapezoidal section and the drum-shaped section of the same vehicle. The transformation of body structure may be realized by replacing five kinds (10 pieces) between trapezoidal and drum-shaped body sections of different vehicle types (A-type trapezoidal and B-type drum-shaped, A-type drum-shaped and B-type trapezoidal).

In addition to the examples described above, other embodiments of the invention are possible. Any technical solution formed by equivalent substitution or equivalent transformation falls within the protection range claimed by the invention.

What is claimed is:

1. An aluminum alloy metro vehicle body section bar capable of matching and combining, comprising a roof section bar, an upper edge beam section bar, a side wall section bar, a lower edge beam section bar and a floor section bar, the adjacent section bars being fixedly connected to form a vehicle body, wherein
the roof section bar comprises roof edge section bars of two widths to respectively adapt to an A-type vehicle and a B-type vehicle;
the upper edge beam section bar comprises an upper edge beam of a drum-shaped vehicle and an upper edge beam of a trapezoidal vehicle to respectively adapt to the drum-shaped vehicle and the trapezoidal vehicle;
the side wall section bar comprises a side wall middle section bar of the drum-shaped vehicle and a side wall middle section bar of the trapezoidal vehicle to respectively adapt to the drum-shaped vehicle and the trapezoidal vehicle;
the lower edge beam section bar comprises a lower edge beam of the drum-shaped vehicle and a lower edge beam of the trapezoidal vehicle to respectively adapt to the drum-shaped vehicle and the trapezoidal vehicle; and
the floor section bar comprises underframe edge section bars of two widths to respectively adapt to the A-type vehicle and the B-type vehicle.

2. The aluminum alloy metro vehicle body section bar capable of matching and combining according to claim 1, wherein the roof section bar comprises a first roof section bar located in a middle of a roof and a second roof section bar located between the first roof section bar and the roof edge section bar; and the first roof section bar, the second roof section bar and the roof edge section bar are fixed in sequence by plug-in connection and welding.

3. The aluminum alloy metro vehicle body section bar capable of matching and combining according to claim 1, wherein the floor section bar comprises a first floor section bar located in a middle of a floor and a second floor section bar located between the first floor section bar and the underframe edge section bar; and the first floor section bar, the second floor section bar and the underframe edge section bar are fixed in sequence by plug-in connection and welding.

4. The aluminum alloy metro vehicle body section bar capable of matching and combining according to claim 1, wherein the side wall section bar comprises a first side wall section bar, a second side wall section bar, a side wall middle section bar and a third side wall section bar successively connected from top to bottom;
the first side wall section bar, the second side wall section bar, the side wall middle section bar and the third side wall section bar are fixed in sequence by plug-in connection and welding;
an upper end of the first side wall section bar is fixed to the upper edge beam by plug-in connection and welding; and
the third side wall section bar is fixed to the lower edge beam section bar by plug-in connection and welding.

5. The aluminum alloy metro vehicle body section bar capable of matching and combining according to claim 1, wherein the drum-shaped vehicle body comprises an upper edge beam of the drum-shaped vehicle, a side wall middle section bar of the drum-shaped vehicle and a lower edge beam of the drum-shaped vehicle; and the trapezoidal vehicle body comprises an upper edge beam of the trapezoidal vehicle, a side wall middle section bar of the trapezoidal vehicle and a lower edge beam of the drum-shaped vehicle.

6. The aluminum alloy metro vehicle body section bar capable of matching and combining according to claim 1, wherein the A-type vehicle body comprises a roof edge section bar of the A-type vehicle with a wider width and an underframe edge section bar of the A-type vehicle with a wider width; and a B-type vehicle body comprises a roof edge section bar of the B-type vehicle with a narrower width and an underframe edge section bar of the B-type vehicle with a narrower width.

7. The aluminum alloy metro vehicle body section bar capable of matching and combining according to claim 1, wherein an A-type drum-shaped vehicle and an A-type trapezoidal vehicle body share a first roof section bar, a second roof section bar, a roof edge section bar of the A-type vehicle, a first side wall section bar, a second side wall section bar, a third side wall section bar, a first floor section bar, a second floor section bar and an underframe edge section bar of the A-type vehicle;
the B-type drum-shaped vehicle and the B-type trapezoidal vehicle body share a first roof section bar, a second roof section bar, a roof edge section bar of the B-type vehicle, a first side wall section bar, a second side wall section bar, a third side wall section bar, a first floor section bar, a second floor section bar and an underframe edge section bar of the B-type vehicle.

8. A method for designing an aluminum alloy metro vehicle body, wherein based on the aluminum alloy metro vehicle body section bar capable of matching and combining according to claim 1, the method adapts to different cross-section vehicle bodies by replacing the roof edge section bar, the upper edge beam of the drum-shaped vehicle and the upper edge beam of the trapezoidal vehicle, the side wall middle section bar of the drum-shaped vehicle and the side wall middle section bar of the trapezoidal vehicle, the lower edge beam of the drum-shaped vehicle, the lower edge beam of the trapezoidal vehicle, and the underframe edge section bar.

9. The method for designing the aluminum alloy metro vehicle body according to claim 8, wherein the operation of converting an A-type vehicle body to a B-type vehicle body comprises replacing the roof edge section bar of the A-type vehicle with the roof edge section bar of the B-type vehicle, and replacing the underframe edge section bar of the A-type vehicle with the underframe edge section bar of the B-type vehicle; wherein a reverse operation is performed when the B-type vehicle body is converted to the A-type vehicle body.

10. The method for designing the aluminum alloy metro vehicle body according to claim 8, wherein the operation of converting the same type of drum-shaped vehicle body into a trapezoidal vehicle body requires the following operations comprising:
replacing the upper edge beam of the drum-shaped vehicle with the upper edge beam of the trapezoidal vehicle,
replacing the side wall middle section bar of the drum-shaped vehicle with the side wall middle section bar of the trapezoidal vehicle, and
replacing the lower edge beam of the drum-shaped vehicle with the lower edge beam of the trapezoidal vehicle;
wherein a reverse operation is performed when the same type of trapezoidal vehicle body is converted into the drum-shaped vehicle body.
